(19) United States
(12) Patent Application Publication
(10) Pub. No.: US 2026/0074226 A1
(43) Pub. Date: Mar. 12, 2026

(54) ELECTRODE FOR RECHARGEABLE LITHIUM BATTERY, RECHARGEABLE LITHIUM BATTERY INCLUDING THE SAME, AND METHOD OF FABRICATING THE SAME

(71) Applicant: SAMSUNG SDI CO., LTD., Yongin-si (KR)

(72) Inventors: Daehyun HONG, Yongin-si (KR); Injoe JUNG, Yongin-si (KR); Yeongap KIM, Yongin-si (KR)

(73) Assignee: SAMSUNG SDI CO., LTD., Yongin-si (KR)

(21) Appl. No.: 19/272,814

(22) Filed: Jul. 17, 2025

(30) Foreign Application Priority Data
Sep. 6, 2024 (KR) 10-2024-0121361

(51) Int. Cl. H01M 4/62; H01M 4/02; H01M 4/139; H01M 10/0525

(52) U.S. Cl. CPC H01M 4/623; H01M 4/139; H01M 10/0525; H01M 2004/021; H01M 2004/027

(57) ABSTRACT

Disclosed are electrodes, rechargeable lithium batteries, and fabrication methods thereof. The electrode includes a current collector, and an electrode active material layer on the current collector. The electrode active material layer includes a groove. The groove includes a filler including a first binder. The first binder in the filler is present in an amount that is equal to or greater than about 90 wt %.

### CROSS-REFERENCE TO RELATED APPLICATION

This application claims priority under 35 U.S.C § 119 to Korean Patent Application No. 10-2024-0121361 filed on Sep. 6, 2024 in the Korean Intellectual Property Office, the disclosure of which is hereby incorporated by reference in its entirety.

### BACKGROUND

The present disclosure relates to an electrode for a rechargeable lithium battery, a rechargeable lithium battery including the electrode, and a method of fabricating the electrode, and more particularly, to an electrode including an electrode active material layer having a groove, a rechargeable lithium battery including the electrode, and a method of fabricating the electrode.

With increasing presence of battery-using electronic devices, such as, e.g., mobile phones, laptop computers, electric vehicles, and the like, there is increasing demand for rechargeable batteries with high energy density and high capacity. Therefore, improving the performance of rechargeable lithium batteries may be advantageous.

A rechargeable lithium battery includes a positive electrode, a negative electrode, and an electrolyte, the positive and negative electrodes include an active material in which intercalation and deintercalation are possible, and the rechargeable lithium battery generates electrical energy caused by oxidation and reduction reactions when lithium ions are intercalated and deintercalated.

### SUMMARY

Some example embodiments of the present disclosure include an electrode for a rechargeable lithium battery having an improved adhesive force between the electrode and a separator.

Some example embodiments of the present disclosure include a rechargeable lithium battery having a desired or improved adhesive force between a separator and an electrode, and enhanced durability and lifespan characteristics.

Some example embodiments of the present disclosure include a method of fabricating a rechargeable lithium battery with improved durability and lifespan characteristics.

According to some example embodiments of the present disclosure, an electrode for a rechargeable lithium battery may include a current collector, and an electrode active material layer on the current collector. The electrode active material layer may include a groove. The groove may be filled with, or may include, a filler including a first binder. The first binder in the filler may be present in an amount that is equal to or greater than about 90 wt %.

According to some example embodiments of the present disclosure, a rechargeable lithium battery may include a first electrode, a second electrode having a polarity that is different from the polarity of the first electrodes, and a separator between the first electrode and the second electrode. At least one of the first electrode and the second electrode may include a current collector and an electrode active material layer on the current collector. The electrode active material layer may include a groove. The groove may be filled with, or include, a filler including a first binder. The separator may include a porous substrate and a coating layer on a surface of the porous substrate. The coating layer may include an inorganic particle and a third binder. The first binder and the third binder may be bonded to each other. One of the first electrode and the second electrode may be combined with the separator.

According to some example embodiments of the present disclosure, a method of fabricating a rechargeable lithium battery may include preparing a first electrode, preparing a second electrode having a polarity that is different from the polarity of the first electrode, and placing a separator between the first electrode and the second electrode to form an electrode assembly. Preparing at least one of the first and second electrodes may include preparing a current collector, forming an electrode active material layer on the current collector, forming a groove on the electrode active material layer, and filling the groove with a filler including a first binder. The first binder in the filler may be present in an amount in a range of about 95 wt % to about 100 wt %.

### BRIEF DESCRIPTION OF DRAWINGS

FIG. 1 illustrates a conceptual diagram showing a rechargeable lithium battery, according to an example embodiment of the present disclosure.

FIGS. 2 to 5 illustrate simplified diagrams showing a rechargeable lithium battery, according to an example embodiment of the present disclosure.

FIG. 6 illustrates a cross-sectional view showing a rechargeable lithium battery, according to an example embodiment of the present disclosure.

FIGS. 7A and 7B illustrate cross-sectional views showing an electrode included in a rechargeable lithium battery, according to an example embodiment of the present disclosure.

FIG. 8 illustrates an enlarged view showing section “N” of FIG. 6.

FIGS. 9A and 9B illustrate plan views showing an electrode included in a rechargeable lithium battery, according to an example embodiment of the present disclosure.

FIG. 10 illustrates a simplified diagram showing a standard for the size of a battery sample used for bending strength measurement, according to an evaluation example.

FIG. 11 is a flow chart illustrating a method of fabricating a rechargeable lithium battery, according to an example embodiment.

### DETAILED DESCRIPTION OF EMBODIMENTS

In order to sufficiently understand the configuration and effect of the present disclosure, some example embodiments of the present disclosure are described with reference to the accompanying drawings. It should be noted, however, that the present disclosure is not limited to the following example embodiments, and may be implemented in various forms. Rather, the example embodiments are provided only to disclose the present disclosure and let those skilled in the art fully know the scope of the present disclosure.

In this description, it is understood that, when an element is referred to as being “on” another element, the element can be “directly on” the other element, or intervening elements may be present therebetween. In the drawings, thicknesses of some components may be exaggerated for effectively explaining the technical contents. Like reference numerals refer to like elements throughout the specification.

Unless otherwise specially noted in this description, the expression of singular form may include the expression of plural form. In addition, unless otherwise specially noted, the phrase “A or B” may indicate “A but not B,” “B but not A,” and “A and B.” The terms “comprises/includes” and/or “comprising/including” used in this description do not exclude the presence or addition of one or more other components.

In this description, the term “combination thereof” may refer to a mixture, a stack, a composite, a copolymer, an alloy, a blend, or a reaction product.

Unless otherwise especially defined in this description, a particle diameter may be an average particle diameter. In addition, a particle diameter indicates an average particle diameter (D₅₀) where a cumulative volume is about 50 volume % in a particle size distribution. The average particle diameter (D₅₀) may be measured by a method widely known to those skilled in the art, for example, by a particle size analyzer, a transmission electron microscope (TEM) image, or a scanning electron microscope (SEM) image. Alternatively, a dynamic light-scattering measurement device is used to perform a data analysis, the number of particles is counted for each particle size range, and then from this, an average particle diameter (D₅₀) value may be obtained through a calculation. Dissimilarly, a laser scattering method may be utilized to measure the average particle diameter (D₅₀). In the laser scattering method, a target particle is distributed in a dispersion solvent, introduced into a laser scattering particle measurement device (e.g., MT3000 commercially available from Microtrac, Inc), irradiated with ultrasonic waves of 28 kHz at a power of 60 W, and then an average particle diameter (D₅₀) is calculated in the 50% standard of particle diameter distribution in the measurement device.

When the terms “about” or “substantially” are included in this specification in connection with a numerical value, it is intended that the associated numerical value include a tolerance of +10% around the stated numerical value. When ranges are specified, the range includes all values therebetween such as increments of 0.1%.

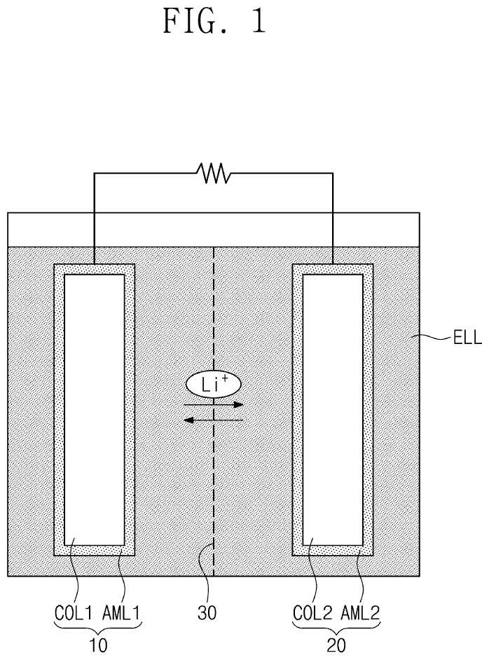

FIG. 1 illustrates a simplified conceptual diagram illustrating a rechargeable lithium battery, according to an example embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be disposed between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be or include a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1, and a positive electrode active material layer AML1 formed on the current collector COL1. The positive electrode active material layer AML1 may include a positive electrode active material, and may further include a binder and/or a conductive material.

For example, the positive electrode 10 may further include an additive that can be configured as a sacrificial positive electrode.

An amount of the positive electrode active material may be in a range of about 90 wt % to about 99.5 wt % relative to 100 wt % of the positive electrode active material layer AML1. An amount of each of the binder and the conductive material may be in a range of about 0.5 wt % to about 5 wt % relative to 100 wt % of the positive electrode active material layer AML1.

The binder may be configured to improve attachment of positive electrode active material particles to each other, and to improve attachment of the positive electrode active material to the current collector COL1. The binder may include, for example, at least one of polyvinyl alcohol, carboxymethyl cellulose, hydroxypropyl cellulose, diacetyl cellulose, polyvinylchloride, carboxylated polyvinylchloride, polyvinylfluoride, ethylene oxide-including polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may be included to provide an electrode with conductivity, and any suitable conductive material that does not cause a chemical change in a battery may be included as the conductive material. The conductive material may include, for example, a carbon-based material such as at least one of natural graphite, artificial graphite, carbon black, acetylene black, Ketjen black, carbon fiber, carbon nano-fiber, and carbon nano-tube; a metal powder or metal fiber including one or more of copper, nickel, aluminum, and silver; a conductive polymer such as a polyphenylene derivative; or a mixture thereof.

Aluminum (Al) may be included as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is or includes at least one of cobalt, manganese, nickel, and a combination thereof.

The composite oxide may include lithium transition metal composite oxide, for example, lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound expressed by one of chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O_{2-α}D_{α} (where 0.90≤a≤1.8, 0≤b≤0.5, 0<α<0.5, and 0<α<2); LiₐNi_{1-b-c}Mn_{b}X_{c}O_{2-α}D_{α} (where 0.90≤a≤1.8, 0≤b≤0.5, 0<α<0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae above, A may be Ni, Co, Mn, or a combination thereof, X may be Al, Ni, Co, Mn, Cr, Fe, Mg, Sr, V, a rare-earth element, or a combination thereof, D may be O, F, S, P, or a combination thereof, G may be Al, Cr, Mn, Fe, Mg, La, Ce, Sr, V, or a combination thereof, and L¹ may be Mn, Al, or a combination thereof.

For example, the positive electrode active material may be a high-nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in lithium transition metal composite oxide. The high-nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material and may further include a binder and/or a conductive material.

For example, the negative electrode active material layer AML2 may include a negative electrode active material of about 90 wt % to about 99 wt %, a binder of about 0.5 wt % to about 5 wt %, and a conductive material of about 0 wt % to about 5 wt %.

The binder may be configured to improve attachment of negative electrode active material particles to each other and also to improve attachment of the negative electrode active material to the current collector COL2. The binder may include a non-aqueous binder, an aqueous binder, a dry binder, or a combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

When an aqueous binder is included as the negative electrode binder, a cellulose-based compound capable of providing viscosity may further be included. The cellulose-based compound may include one or more of carboxymethyl cellulose, hydroxypropylmethyl cellulose, methyl cellulose, and alkali metal salts thereof. The alkali metal may include at least one of Na, K, or Li.

The dry binder may include a fibrillizable polymer material, for example, at least one of polytetrafluoroethylene, polyvinylidene fluoride, polyvinylidene fluoride-hexafluoropropylene copolymer, polyethylene oxide, or a combination thereof.

The conductive material may be included to provide an electrode with conductivity, and any suitable conductive material that does not cause a chemical change in a battery may be included as the conductive material. For example, the conductive material may include a carbon-based material such as at least one of natural graphite, artificial graphite, carbon black, acetylene black, Ketjen black, carbon fiber, carbon nano-fiber, and carbon nano-tube; a metal powder or metal fiber including one or more of copper, nickel, aluminum, and silver; a conductive polymer such as a polyphenylene derivative; or a mixture thereof.

The current collector COL2 may include at least one of a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include at least one of a material that can reversibly intercalate and deintercalate lithium ions, lithium metal, a lithium metal alloy, a material that can dope and de-dope lithium, or a transition metal oxide.

The material that can reversibly intercalate and deintercalate lithium ions may include a carbon-based negative electrode active material such as, for example, crystalline carbon, amorphous carbon, or a combination thereof. For example, the crystalline carbon may include graphite such as non-shaped, sheet-shaped, flake-shaped, sphere-shaped, or fiber-shaped natural or artificial graphite, and the amorphous carbon may include at least one of soft carbon, hard carbon, mesophase pitch carbon, or calcined coke.

The lithium metal alloy may include an alloy of lithium and a metal that is or includes at least one of Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include at least one of silicon, silicon-carbon composite, SiOₓ (where 0<x<2), Si-Q alloy (where Q is or includes at least one of alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include at least one of Sn, SnO₂, a Sn-based alloy, a combination thereof.

The silicon-carbon composite may be or include a composite of silicon and amorphous carbon. According to an example embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) positioned on a surface of the secondary particle. The amorphous carbon may also be positioned between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles, and may also include an amorphous carbon coating layer on a surface of the core.

The Si-based negative electrode active material or the Sn-based negative electrode active material may be included in combination with a carbon-based negative electrode active material.

### Separator 30

Based on a type of the rechargeable lithium battery, the separator 30 may be present between the positive electrode 10 and the negative electrode 20. The separator 30 may include one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one side, or on opposite sides, of the porous substrate, the coating layer including at least one of an organic material, an inorganic material, or a combination thereof.

The porous substrate may be or include a polymer layer including at least one of polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be a copolymer or mixture including at least two or more of the materials mentioned above.

The organic material may include a polyvinylidenefluoride-based copolymer or a (meth)acrylic copolymer.

The inorganic material may include an inorganic particle such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be mixed in one coating layer, or may be present as a stack of a coating layer including the organic material and a coating layer including an inorganic material.

### Electrolyte ELL

The electrolyte ELL for a rechargeable lithium battery may include a non-aqueous organic solvent and a lithium salt.

The non-aqueous organic solvent may be configured as a medium for transmitting ions that participate in an electrochemical reaction of the battery.

The non-aqueous organic solvent may include at least one of a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include at least one of methyl acetate, ethyl acetate, n-propyl acetate, dimethyl acetate, methyl propionate, ethyl propionate, decanolide, mevalonolactone, valerolactone, or caprolactone.

The ether-based solvent may include at least one of dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The alcohol-based solvent may include at least one of ethyl alcohol or isopropyl alcohol, and the aprotic solvent may include at least one of nitriles such as R-CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolanes.

The non-aqueous organic solvent may be included alone or in a mixture of two or more substances.

In addition, when a carbonate-based solvent is included, a cyclic carbonate and a linear carbonate may be mixed, and the cyclic carbonate and the linear carbonate may be mixed in a volume ratio in a range of about 1:1 to about 1:9.

The lithium salt may be or include a material that dissolves in the non-aqueous organic solvent to constitute as a supply source of lithium ions in a battery, and plays a role in enabling a basic operation of a rechargeable lithium battery and in promoting the movement of lithium ions between positive and negative electrodes. The lithium salt may include, for example, at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethanesulfonate, lithium difluoro (oxalato) borate (LiDFOB), lithium difluorobis(oxalato)phosphate (LiDFBOP), and lithium bis(oxalato) borate (LiBOB)

### Rechargeable Lithium Battery

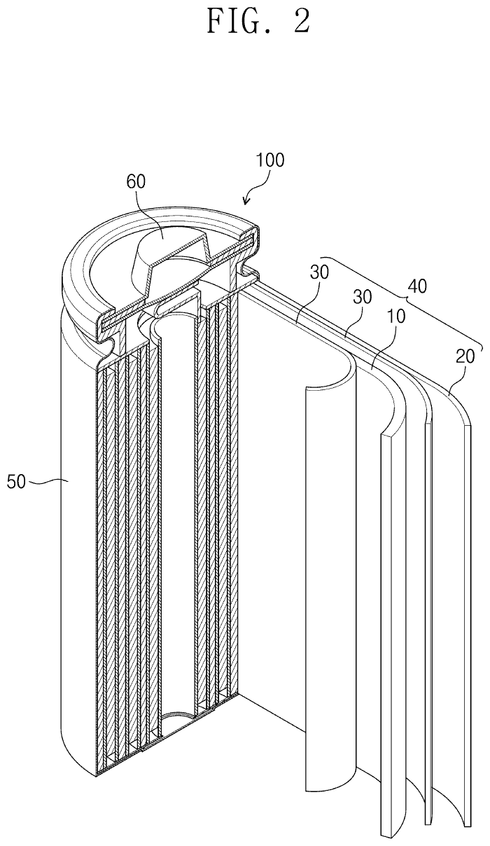

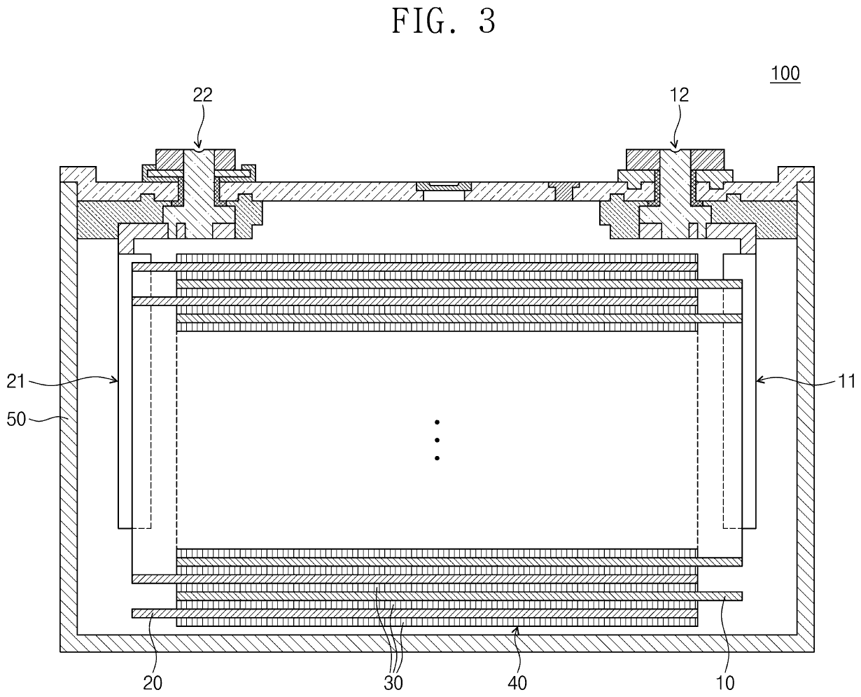

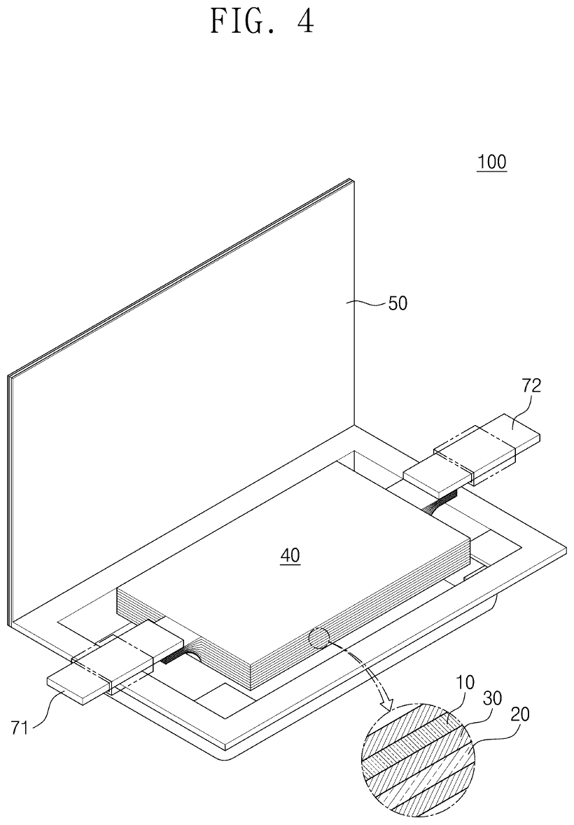

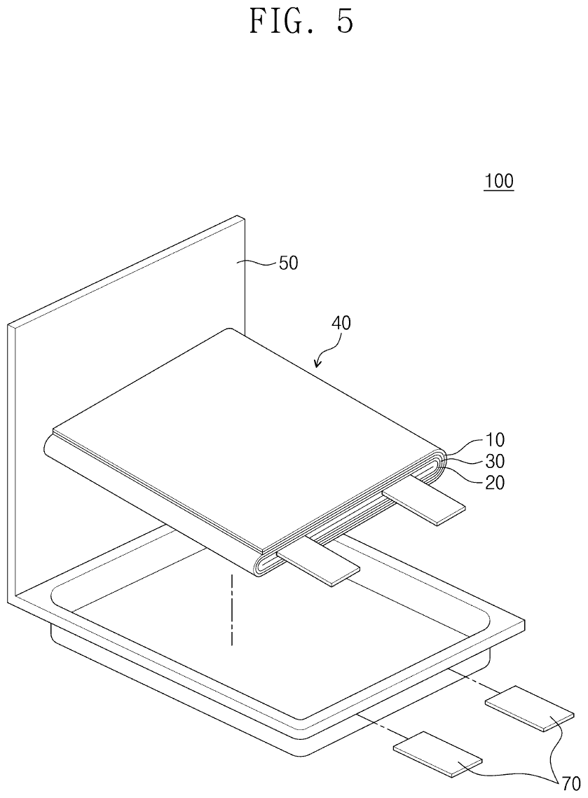

Based on a shape of a rechargeable lithium battery, the rechargeable lithium battery may be classified into cylindrical, prismatic, pouch, and coin types. FIGS. 2 to 5 are simplified diagrams illustrating a rechargeable lithium battery, according to an example embodiment, with FIG. 2 illustrating a cylindrical battery, FIG. 3 illustrating a prismatic battery, and FIGS. 4 and 5 illustrating pouch-type batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50 as illustrated in FIG. 2. In addition, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70 illustrated in FIG. 5, or a positive electrode tab 71 and a negative electrode tab 72 illustrated in FIG. 4, the electrode tabs 70/71/72 forming an electrical path for externally inducing a current generated in the electrode assembly 40.

The following describes in detail a rechargeable lithium battery, according to some example embodiments of the present disclosure, and an electrode included therein.

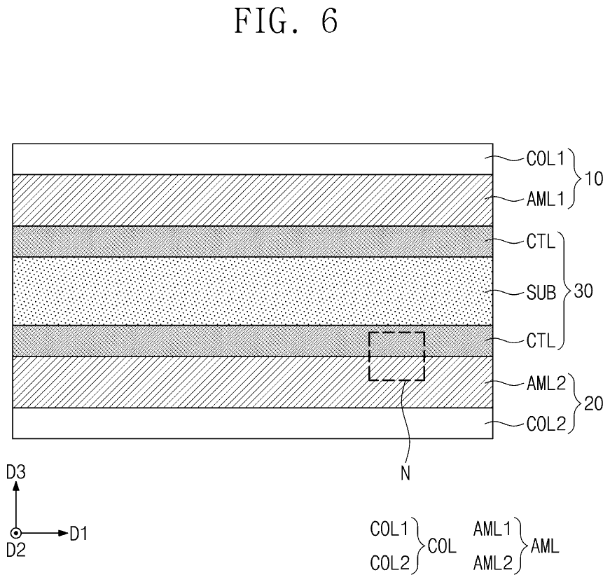

FIG. 6 illustrates a cross-sectional view showing a rechargeable lithium battery, according to an example embodiment of the present disclosure.

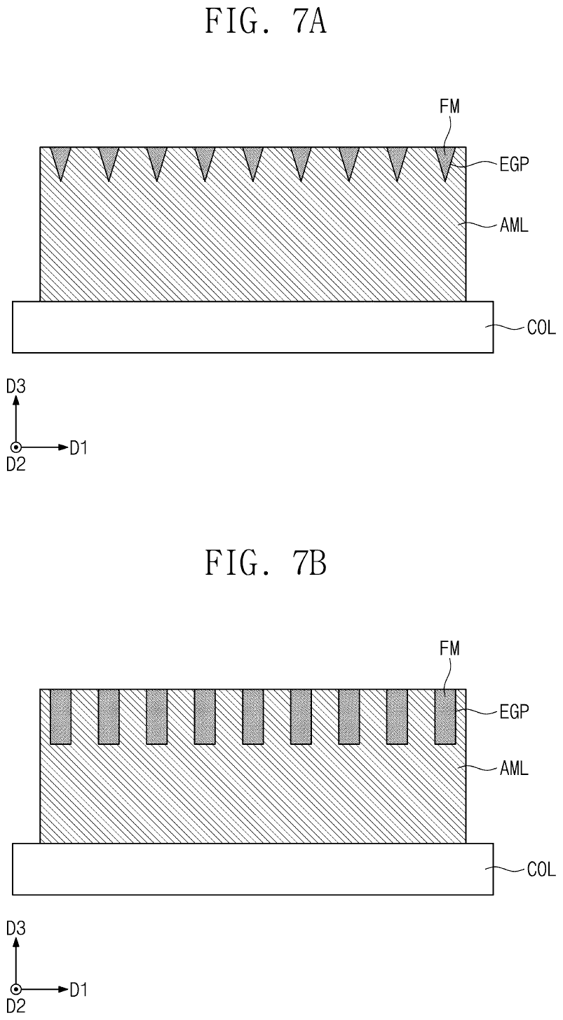

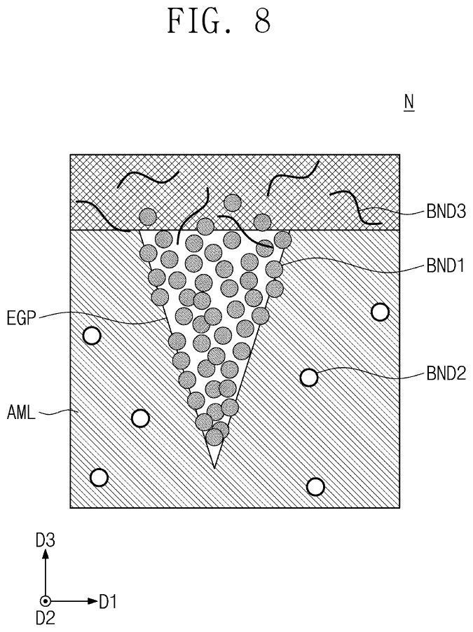

FIGS. 7A and 7B illustrate cross-sectional views showing an electrode included in a rechargeable lithium battery, according to an example embodiment of the present disclosure. FIG. 8 illustrates an enlarged view showing section N of FIG. 6.

Referring to FIG. 6, as discussed above with reference to FIG. 1, a rechargeable lithium battery according to the present disclosure may include a positive electrode 10, a negative electrode 20, and a separator 30 between the positive electrode 10 and the negative electrode 20. Although not explicitly shown in FIG. 6, the rechargeable lithium battery according to the present disclosure may further include an electrolyte ELL. The separator 30 may be impregnated in the electrolyte ELL. The following description focuses on the separator 30, the positive electrode 10, and the negative electrode 20 included in the rechargeable lithium battery.

The separator 30 may include a porous substrate SUB and a coating layer CTL on a surface of the porous substrate SUB. The porous substrate SUB and the coating layer CTL may be the same as or similar to those discussed with reference to FIG. 1.

For example, the porous substrate SUB may be or include a polymer layer including at least one of polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon™, and polytetrafluoroethylene, or may be or include a copolymer or a mixture including two or more of the materials mentioned above.

The coating layer CTL may include an organic material, an inorganic material, or a combination thereof, and may further include a third binder. The organic material may include a polyvinylidenefluoride-based copolymer or a (meth)acrylic copolymer. The inorganic material may include an inorganic particle such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The third binder included in the coating layer CTL may include at least one of a fluorine-based binder and an acrylic binder. For example, the third binder may include at least one of polymethylmethacrylate, polymethylacrylate, polyethylacrylate, polyacrylic acid, polyacrylonitrile, polyvinylidenefluoride, polytetrafluoroethylene, and vinylidenefluoride/hexafluoropropylene copolymer.

An amount of the third binder in the coating layer CTL may be changed based on a type of battery. For example, in the case of a pouch-type battery that may be vulnerable to external physical impact due to the low mechanical strength of an exterior housing that encloses the electrode assembly, an improved adhesive force may be required between the separator 30 and the electrode 10 or 20 such that the coating layer CTL may include a higher amount of binder compared to cylindrical or prismatic batteries. For example, in the case of a pouch cell, the third binder in the coating layer CTL may be present in an amount in a range of about 10 wt % to about 60 wt %, about 20 wt % to about 50 wt %, or about 20 wt % to about 40 wt %.

Referring to FIGS. 7A, 7B, and 8, the electrode 10 or 20 included in the rechargeable lithium battery according to an example embodiment may include a current collector COL and an electrode active material layer AML disposed on at least one surface of the current collector COL. The electrode active material layer AML may include an electrode active material and a second binder BND2.

The electrode active material layer AML may correspond to the positive electrode active material layer AML1 or the negative electrode active material layer AML2 discussed above with reference to FIG. 1. When the electrode active material layer AML is the positive electrode active material layer AML1, the electrode active material layer AML1 may include a positive electrode active material and a second binder BND2, and may further include a conductive material. When the electrode active material layer AML is the negative electrode active material layer AML2, the electrode active material layer AML2 may include a negative electrode active material and a second binder BND2, and may further include a conductive material. The negative electrode active material and the positive electrode active material may be the same as or similar to the negative electrode active material and the positive electrode active material discussed with reference to FIG. 1.

In some example embodiments of the present disclosure, the second binder BND2 may include an aqueous binder. The aqueous binder may include at least one of styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

The second binder BND2 may further include, in addition to the aqueous binder, a cellulose-based compound capable of providing viscosity. The cellulose-based compound may include one or more of carboxymethyl cellulose, hydroxypropylmethyl cellulose, methyl cellulose, and alkali metal salts thereof.

In an example embodiment, the second binder BND2 may include carboxymethyl cellulose along with a rubber-based aqueous binder such as, e.g., styrene-butadiene rubber (SBR).

Referring back to FIGS. 7A, 7B, and 8, the electrode active material layer AML may include a groove EGP. The groove EGP may be filled with, or may include, a filler FM including a first binder BND1. The first binder BND1 in the filler FM may be present in an amount that is equal to or greater than about 90 wt %. For example, the first binder BND1 in the filler FM may be present in an amount in a range of about 95 wt % to about 100 wt %. The filler FM may be substantially formed of or may include only the first binder BND1.

The filler FM may occupy approximately 80 vol % or more relative to the total 100 vol % of the groove EGP. For example, the filler FM may occupy about 85 vol % to about 100 vol % relative to the total 100 vol % of the groove EGP. When the filler FM including the first binder BND1 occupies a volume that is equal to or greater than about 80 vol % relative to the total volume of the groove EGP, the third binder BND3 of the separator 30 may be anchored into the filler FM and adhered to the first binder BND1, thereby improving an adhesive force between the separator 30 and the electrode 10 or 20. A detailed effect of the improved adhesive force is discussed below with reference to FIG. 8.

The first binder BND1 may include at least one of a fluorine-based binder and an acrylic binder, and may be the same as or similar to the third binder BND3 included in the separator 30. For example, the first binder BND1 may include at least one of polymethylmethacrylate, polymethylacrylate, polyethylacrylate, polyacrylic acid, polyacrylonitrile, polyvinylidenefluoride, polytetrafluoroethylene, and vinylidenefluoride/hexafluoropropylene copolymer.

There is no particular limitation on a shape of the first binder BND1, and for example, the first binder BND1 may be or include a particulate binder and/or an amorphous binder. When the first binder BND1 is a particulate binder, the binder may have an average particle diameter in a range of about 100 nm to about 900 nm, about 200 nm to about 700 nm, or about 250 nm to about 500 nm. When the size of the first binder BND1 falls within the range above, the first binder BND1 may sufficiently fill the groove EGP, and may have a desired or improved adhesive force.

When the groove EGP is filled with, or includes, the first binder BND1, an increased adhesive force may be provided between the separator 30 and the electrode 10 or 20. Referring to FIG. 8, the third binder BND3 included in the separator 30 may be anchored into the groove EGP, and thus adhesion may be achieved to improve an adhesive force. In addition, the third binder BND3 of the separator 30 and the first binder BND1 of the groove EGP may be bonded to cause an improvement in the adhesive force between the separator 30 and the electrode 10 or 20.

The second binder BND2 and the third binder BND3 may have physicochemical properties that are different from each other. Thus, it may be challenging to anchor the third binder BND3 to the electrode active material layer AML which includes the second binder BND2. The first binder BND1 and the third binder BND3 may have physicochemical properties that are identical or similar to each other. The similarity of physicochemical properties between two binders may facilitate the anchoring of the third binder BND3 to the groove EGP including the first binder BND1.

In a comparative example of the present disclosure, the groove EGP may be omitted from the electrode active material layer AML, and thus the first binder BND1 may not be included in the electrode active material layer AML. The electrode active material layer AML according to the comparative example of the present disclosure may include only the second binder BND2. As a result, it may be challenging to anchor the electrode active material layer AML according to the comparative example of the present disclosure to the third binder BND3 of the separator 30. For example, there may be a relatively reduced adhesive force between the separator 30 and the electrode active material layer AML according to the comparative example of the present disclosure.

In contrast, according to some example embodiments of the present disclosure, the electrode active material layer AML may include the groove EGP filled with the first binder BND1, and thus the third binder BND3 of the separator 30 may be anchored to the first binder BND1 of the groove EGP. The first binder BND1 of the electrode active material layer AML and the third binder BND3 of the separator 30 may be strongly bonded to improve an adhesive force between the separator 30 and the electrode 10 or 20.

In some example embodiments of the present disclosure, a depth of the groove EGP may be in a range of about 5% to about 90%, about 10% to about 80%, or about 20% to about 60% of a thickness of the electrode active material layer AML. In an example embodiment, the depth of the groove EGP may range from about 10 μm to about 50 μm, from about 10 μm to about 40 μm, or from about 20 μm to about 30 μm.

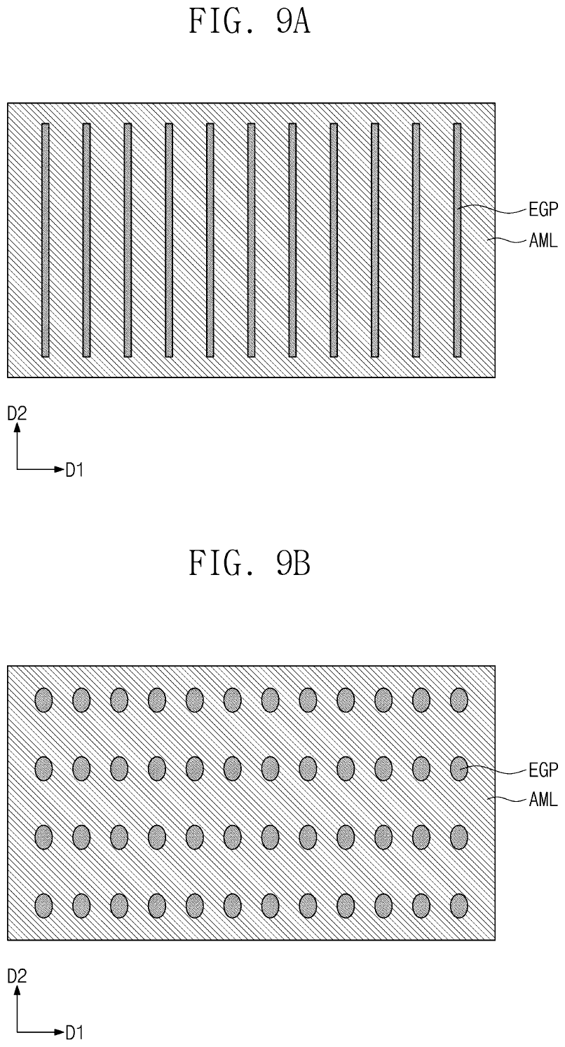

FIGS. 9A and 9B illustrate plan views showing an electrode included in a rechargeable lithium battery, according to an example embodiment of the present disclosure.

Referring to FIG. 9A, the groove EGP may have a shape in which a plurality of lines are spaced apart from each other and are parallel to each other. The plurality of lines may be formed in a direction D2 that is parallel to a minor axis of the electrode active material layer AML and orthogonal to a major axis of the electrode active material layer AML. When the groove EGP is shaped like a plurality of lines, an average width of the plurality of lines may range from about 40 μm to about 70 μm, or from about 50 μm to about 60 μm.

Referring to FIG. 9B, the groove EGP may have a shape in which a plurality of holes are spaced apart from each other. An average diameter of the plurality of holes may range from about 40 μm to about 70 μm or from about 50 μm to about 60 μm.

In some example embodiments, there is no particular limitation on a cross-sectional shape of the groove EGP, and for example, the groove EGP may have a cylindrical shape, a circular columnar shape, or a tetragonal columnar shape (see FIGS. 7A and 7B).

The following describes a method of fabricating a rechargeable lithium battery, according to some example embodiments of the present disclosure.

A method of fabricating a rechargeable lithium battery according to an example embodiment may include preparing a first electrode, preparing a second electrode having a polarity that is different from the polarity of the first electrode, and forming an electrode assembly by placing a separator between the first electrode and the second electrode.

The preparation of at least one of the first electrode and the second electrode may include preparing an electrode current collector, forming an electrode active material layer on the electrode current collector, forming a groove on the electrode active material layer, and filling the groove with a filler including a first binder.

In an example embodiment, the formation of the groove on the electrode active material layer may include performing a laser process. The laser process may use laser pulses of various wavelengths (e.g., femtosecond laser, picoseconds laser, nanosecond laser, and so forth). The groove formed by the laser process may have a shape in which a plurality of lines are spaced apart from each other and are parallel to each other. The plurality of lines may be formed in a direction that is parallel to a minor axis of the electrode active material layer and orthogonal to a major axis of the electrode active material layer. When the groove is shaped like a plurality of lines, an average width of the plurality of lines may range from about 40 μm to about 70 μm, or from about 50 μm to about 60 μm.

In an example embodiment, the formation of the groove on the electrode active material layer may include performing a process that uses a needle roller. The groove formed by using the needle roller may have a shape in which a plurality of holes are spaced apart from each other. An average diameter of the plurality of holes may range from about 40 μm to about 70 μm, or from about 50 μm to about 60 μm.

The filling of the groove with the filler including the first binder may include filling the groove with a binder solution including the first binder, and performing a dry process to remove a solvent from the groove.

In an example embodiment, the binder solution may include the solvent and the first binder, and may further include an additive. When the binder solution further includes the additive, a weight ratio of the additive to the binder included in the solution may be equal to or less than about 0.1. The first binder in the binder solution may be present in an amount in a range of about 5 wt % to about 20 wt % relative to the total weight of the solution.

The solution of the binder solution may be or include a deionized water solvent or an organic solvent. There is no particular limitation on a kind of organic solvent, and for example, the organic solvent may include at least one of acetone, xylene, N-methyl-2-pyrrolidone, diethylbenzene, diethylene carbonate, dimethylacetamide, dimethyl carbonate, and ethylene carbonate.

The dry process for removing the solvent may be performed at a temperature in a range of about 40° C. to about 90° C. for about 10 minutes to about 60 minutes. When the temperature and the time fall within the ranges above, the solvent may be sufficiently removed from the groove.

After the removal of the solvent, the filler including the first binder may occupy approximately 80 vol % or more relative to the total 100 vol % of the groove. For example, the filler may occupy a range of about 90 vol % to about 100 vol % relative to the total 100 vol % of the groove.

The method of fabricating a rechargeable lithium battery, according to some example embodiments of the present disclosure, may further include using a pouch film to pack the manufactured electrode assembly. The pouch film may include metal having flexibility while maintaining mechanical strength. For example, the pouch film may include aluminum (Al). The pouch film may further include, in addition to aluminum, a metal including at least one of iron (Fe), carbon (C), chromium (Cr), manganese (Mn), and nickel (Ni).

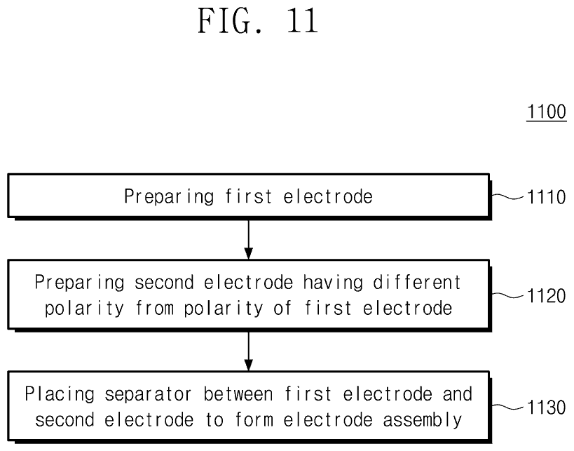

FIG. 11 is a flow chart illustrating a method of fabricating a rechargeable lithium battery, according to an example embodiment. In FIG. 11, the method 1100 includes operation 1110, which includes preparing a first electrode. Operation 1120 includes preparing a second electrode having a polarity that is different from a polarity of the first electrode. In examples, at least one of operation 1110 and operation 1120 includes preparing a current collector, forming an electrode active material layer on the current collector, forming a groove on the electrode active material layer, and filling the groove with a filler including a first binder. For example, the first binder in the filler is present in an amount in a range of about 95 wt % to about 100 wt %. In another example, forming the groove includes performing a laser ablation on the electrode active material layer. In yet another example, filling the groove with the filler including the first binder includes filling the groove with a binder solution including the first binder, and drying the binder solution that fills the groove. Operation 1130 includes placing a separator between the first electrode and the second electrode to form an electrode assembly.

The following description focuses on some example embodiments of the present disclosure. The following example embodiments are provided to aid in understanding of the present disclosure and are not intended to limit the scope of the present disclosure.

### Example 1

### Manufacture of Negative Electrode:

A negative electrode active material slurry was prepared by mixing, in a weight ratio of 98:2, graphite powder (Japan carbon) as a negative electrode active material and a mixture including styrene-butadiene rubber (SBR) and carboxymethyl cellulose (CMC) mixed in a weight ratio of 1:1. The prepared negative electrode active material slurry was coated on a copper foil current collector of 8 μm in thickness, and the coated electrode plate was dried at 100° C. for 1 hour or more, and then the resultant product was pressed to manufacture a first negative electrode plate. A thickness of the manufactured first negative electrode plate was about 120 μm.

A negative electrode active material layer of the first negative electrode plate underwent a laser ablation to form a groove with a shape having a plurality of lines spaced apart from each other. A depth of the groove was about 25 μm, and a width of each of the plurality of lines was about 60 μm.

A polyvinylidene fluoride (PVdF) binder having an average particle diameter of about 250 nm was added to distilled water to prepare a binder solution in which the binder amount was 5.0 wt %. The binder solution was packed to completely fill the groove, and dried at 80° C. for 30 minutes or more to manufacture a negative electrode plate where the groove was filled with the polyvinylidene fluoride (PVdF) binder.

### Manufacture of Positive Electrode:

LiCoO₂ as a positive electrode active material, Super P™ as a carbonaceous conductive material, and a polyvinylidene fluoride (PVdF) solution as a binder were added and mixed to prepare an active material slurry. In the active material slurry, the active material, the conductive material, and the binder were mixed in a weight ratio of 98.5:0.5:1. A thick-film coater was utilized to coat the active material slurry on opposite sides of an aluminum current collector having a thickness of 12 μm, and the resultant product was dried at 120° C. for 1 hour or more, followed by a roll press to manufacture a positive electrode plate.

### Manufacture of Separator:

25 wt % of alumina (Al₂O₃) (LS-71A commercially available from Nippon Light Metal Company Ltd.) was added to acetone, and milled and dispersed at 25° C. for 4 hours using Beads Mill to prepare an inorganic dispersion solution. The inorganic dispersion solution and the polyvinylidene fluoride (PVdF) binder solution were mixed to have an amount ratio of 30:70 between a binder and inorganic particles (alumina), thereby manufacturing a composition for forming a coating layer.

The composition for forming the coating layer was coated at a rate of 20 m/min on opposite sides of a polyethylene film (PE commercially available from SK Innovation Co. Ltd.) of 7.0 μm in thickness by using a direct metering method to achieve a thickness of 1.5 μm per side (total 3.0 μm), and then dried at a temperature of 50° C. under the absolute humidity (average value) of 11 g/cm³ to manufacture a separator for a rechargeable battery.

### Fabrication of Rechargeable Lithium Battery

The separator was interposed between the positive electrode and the negative electrode to prepare a wound jelly-roll-type electrode assembly. After the electrode assembly was received in a pouch, the pouch was injected with an electrolyte in which 1.15 M of LiPF₆ was added to a solvent including ethylene carbonate, ethylmethyl carbonate, and diethyl carbonate mixed in a volume ratio of 3:5:2, and then sealed to fabricate a rechargeable lithium battery. A thickness of the rechargeable lithium battery was 5.12 mm.

### Example 2

A negative electrode and a rechargeable lithium battery were each fabricated in the same method as in Embodiment 1, with a difference that the PVdF binder having an average particle diameter of about 250 nm was replaced with a PVdF binder having an average particle diameter of about 500 nm in preparing the binder solution filling the groove when the negative electrode was manufactured.

### Example 3

A negative electrode and a rechargeable lithium battery were each fabricated in the same method as in Embodiment 1, with a difference that the PVdF binder having an average particle diameter of about 250 nm was replaced with an acrylate binder having an average particle diameter of about 350 nm in preparing the binder solution filling the groove when the negative electrode was manufactured.

### Example 4

A negative electrode and a rechargeable lithium battery were each fabricated in the same method as in Embodiment 1, with a difference that the laser ablation was replaced with a needle roller to form a groove with a shape having a plurality of holes spaced apart from each other when the groove was formed on the negative electrode active material layer.

A depth of the groove was about 25 μm, and an average particle diameter of a plurality of holes was about 55 μm.

### Example 5

A negative electrode and a rechargeable lithium battery were each fabricated in the same method as in Embodiment 4, with a difference that the PVdF binder having an average particle diameter of about 250 nm was replaced with a PVdF binder having an average particle diameter of about 500 nm in preparing the binder solution filling the groove when the negative electrode was manufactured.

### Example 6

A negative electrode and a rechargeable lithium battery were each fabricated in the same method as in Embodiment 4, with a difference that the PVdF binder having an average particle diameter of about 250 nm was replaced with an acrylate binder having an average particle diameter of about 350 nm in preparing the binder solution filling the groove when the negative electrode was manufactured.

### Example 7

A negative electrode and a rechargeable lithium battery were each fabricated in the same method as in Embodiment 4, with a difference that the PVdF binder having an average particle diameter of about 250 nm was replaced with an amorphous PVdF binder in preparing the binder solution filling the groove when the negative electrode was manufactured.

### Comparative Example 1

A negative electrode active material slurry was prepared by mixing, in a weight ratio of 98:2, graphite powder (Japan carbon) as a negative electrode active material and a mixture including styrene-butadiene rubber (SBR) and carboxymethyl cellulose (CMC) mixed in a weight ratio of 1:1. The prepared negative electrode active material slurry was coated on a copper foil current collector of 8 μm in thickness, and the coated electrode plate was dried at 100° C. for 1 hour or more, and then the resultant product was pressed to manufacture a first negative electrode plate. Except for that mentioned above, a positive electrode, a separator, and a rechargeable lithium battery were each fabricated in the same method as in Embodiment 1.

### Comparative Example 2

A negative electrode and a rechargeable lithium battery were each fabricated in the same method as in Embodiment 1, with a difference that the groove was empty without being filled with the binder solution when the negative electrode was manufactured.

### Comparative Example 3

A negative electrode and a rechargeable lithium battery were each fabricated in the same method as in Embodiment 4, with a difference that the groove was empty without being filled with the binder solution when the negative electrode was manufactured.

### Evaluation

The evaluation of cell thickness and cell bending strength was conducted on the rechargeable lithium batteries fabricated according to the examples and the comparative examples. The evaluation method was as follows.

The rechargeable lithium batteries fabricated in the examples and the comparative examples were each charged at 25° C. with a constant current of 0.1 C rate until a voltage reached 4.4 V (vs. Li), and then the current was cut-off at 0.05 C rate while a voltage was maintained at 4.4 V in a constant voltage mode. Then, each of the lithium metal batteries was discharged with a constant current of about 0.1 C rate until a voltage reached 2.8V (vs. Li) (formation cycle). The rechargeable lithium battery that has undergone the formation process was charged at 25° C. with a constant current of 0.5 C rate until a voltage reached 4.4 V (vs. Li). Then, the rechargeable lithium battery was discharged at 25° C. with a constant current of about 0.5 C rate, and this cycle was repeated under the same condition up to a 100th cycle (10 times). In all charge-discharge cycles, a 10-minute resting time was provided after each charge-discharge cycle.

Afterwards, the rechargeable lithium battery was charged to a state of charge (SOC) of 70%, and the cell thickness and bending strength were measured in the following method.

A vernier caliper was used to measure the cell thickness, and the result is shown in Table 1 below.

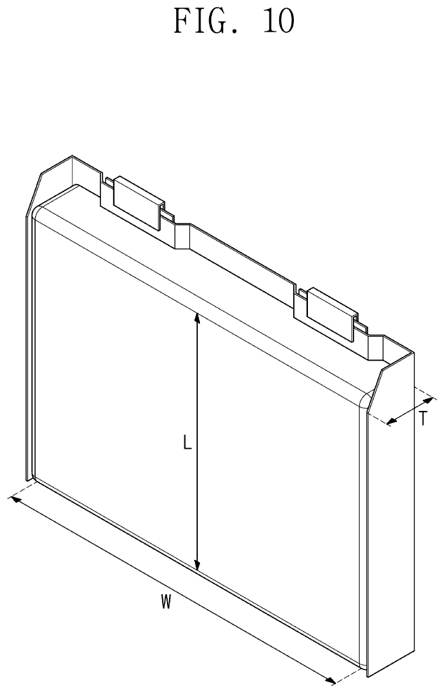

For the measurement of the bending strength, a rechargeable lithium battery sample was prepared to a size of 55 mm (L)×75 mm (W)×5.12 mm (T) based on length L, width W, and thickness T of FIG. 10. After a middle point of the length L of the sample was positioned at a right center of the span of a bending strength analyzer, a jig equipped with a load cell with a maximum load of 1 kN vertically pressed at a rate of 5 mm/min to measure a maximum strength when the battery was bent, and the bending strength was calculated and listed in Table 1. Single column (Instron-3344) was used as the bending strength analyzer, and the bending strength was calculated according to Mathematical Equation 1 below.

$$Bending strength ( N ) = \frac{3 \times ( maximum strength ) \times ( support interval , L )}{2 \times ( battery height , H ) \times {( battery thickness , T )}^{2}} \qquad Mathematical Equation 1$$

TABLE 1

| | | | Average | Cell | Bending |
|---|---|---|---|---|---|
| | Pattern | | particle | thickness | strength |
| | shape of | | diameter | after 10 | after 10 |
| | electrode | Type of | of binder | cycles | cycles |
| | plate | binder | (nm) | (mm) | (N) |
| Example 1 | Line | PVdF | 250 | 5.172 | 514 |
| Example 2 | Line | PVdF | 500 | 5.161 | 563 |
| Example 3 | Line | Acrylate | 350 | 5.156 | 580 |
| Example 4 | Hole | PVdF | 250 | 5.181 | 473 |
| Example 5 | Hole | PVdF | 500 | 5.179 | 489 |
| Example 6 | Hole | Acrylate | 350 | 5.169 | 549 |
| Example 7 | Hole | PVdF | Amorphous | 5.146 | 610 |
| | | | binder | | |
| Comparative | No pattern | No binder | — | 5.253 | 375 |
| Example 1 | | | | | |
| Comparative | Line | No binder | — | 5.207 | 405 |
| Example 2 | | | | | |
| Comparative | Hole | No binder | — | 5.228 | 389 |
| Example 3 | | | | | |

Referring to Table 1, it may be observed that a variation in cell thickness after 10 cycles is lower in the rechargeable lithium battery according to the examples than in the rechargeable lithium battery according to the comparative examples. This may denote that the rechargeable lithium battery according to the examples has a desired or improved adhesive force between an electrode and a separator.

Referring back to Table 1, it may be observed that a bending strength after 10 cycles is greater in the rechargeable lithium battery according to the examples than in the rechargeable lithium battery according to the comparative examples. This may denote that the rechargeable lithium battery according to the examples has improved durability.

In an electrode for a rechargeable lithium battery according to the present disclosure, an electrode active material layer may include a groove, and the groove may be filled with a binder. Therefore, an electrode and a separator may have an increased adhesive force therebetween, and the battery may have improved durability and lifespan characteristics.

The above descriptions are detailed example embodiments for implementing the present disclosure. The present disclosure includes not only the above example embodiments but also embodiments that can be readily modified or simply redesigned. Additionally, the present disclosure includes technologies that can be readily modified and implemented using the described example embodiments. Therefore, the scope of the present disclosure should not be limited to the aforementioned example embodiments, but should be defined by the following claims as well as their equivalents.

What is claimed is:

1. An electrode for a rechargeable lithium battery, the electrode comprising:
a current collector; and
an electrode active material layer on the current collector,
wherein the electrode active material layer comprises a groove,
wherein the groove includes a filler comprising a first binder,
wherein the first binder in the filler is present in an amount that is equal to or greater than about 90 wt %.

2. The electrode of claim 1, wherein the first binder in the filler is present in an amount in a range of about 95 wt % to about 100 wt %.

3. The electrode of claim 1, wherein the filler occupies approximately about 80 vol % or more relative to total 100 vol % of the groove.

4. The electrode of claim 1, wherein the first binder comprises at least one of a fluorine-based binder and an acrylic binder.

5. The electrode of claim 1, wherein the first binder comprises at least one of polymethylmethacrylate, polymethylacrylate, polyethylacrylate, polyacrylic acid, polyacrylonitrile, polyvinylidenefluoride, polytetrafluoroethylene, and vinylidenefluoride/hexafluoropropylene copolymer.

6. The electrode of claim 1, wherein the first binder has a particulate shape.

7. The electrode of claim 1, wherein:
the electrode active material layer comprises a second binder, and
the second binder comprises an aqueous binder and a cellulose-based compound.

8. The electrode of claim 1, wherein the electrode is a negative electrode.

9. The electrode of claim 1, wherein a depth of the groove is in a range of about 5% to about 90% of a thickness of the electrode active material layer.

10. The electrode of claim 1, wherein a depth of the groove is in a range of about 20 μm to about 30 μm.

11. The electrode of claim 1, wherein the groove has a shape in which a plurality of lines are spaced apart from each other and are parallel to each other,
wherein the plurality of lines are parallel to a minor axis of the electrode active material layer, and
wherein an average width of the plurality of lines is in a range of about 40 μm to about 70 μm.

12. The electrode of claim 1, wherein the groove has a shape in which a plurality of holes are spaced apart from each other,
wherein an average diameter of the plurality of holes is in a range of about 40 μm to about 70 μm.

13. A rechargeable lithium battery, comprising:
a first electrode;
a second electrode having a polarity that is different from a polarity of the first electrode; and
a separator between the first electrode and the second electrode,
wherein at least one of the first electrode and the second electrode comprises a current collector and an electrode active material layer on the current collector,
wherein the electrode active material layer comprises a groove,
wherein the groove includes a filler comprising a first binder,
wherein the separator comprises a porous substrate and a coating layer on a surface of the porous substrate,
wherein the coating layer comprises an inorganic particle and a third binder,
wherein the first binder and the third binder are bonded to each other, and
wherein one of the first electrode and the second electrode is combined with the separator.

14. The rechargeable lithium battery of claim 13, wherein:
the first electrode is a negative electrode,
the negative electrode comprises a negative electrode current collector and a negative electrode active material layer on the negative electrode current collector,
the negative electrode active material layer comprises a groove,
the groove includes a filler comprising a first binder, and
the first binder is present in an amount that is equal to or greater than about 95 wt % in the filler.

15. The rechargeable lithium battery of claim 14, wherein:
the negative electrode active material layer comprises a second binder, and
the second binder comprises an aqueous binder and a cellulose-based compound.

16. The rechargeable lithium battery of claim 13, wherein at least one of the first binder and the third binder comprises at least one of a fluorine-based binder and an acrylic binder.

17. The rechargeable lithium battery of claim 13, wherein the third binder in the coating layer is present in an amount in a range of about 20 wt % to about 40 wt %.

18. A method of fabricating a rechargeable lithium battery, the method comprising:
preparing a first electrode;
preparing a second electrode having a polarity that is different from a polarity of the first electrode; and
placing a separator between the first electrode and the second electrode to form an electrode assembly,
wherein at least one of preparing the first electrode and preparing the second electrodes comprises:
preparing a current collector;
forming an electrode active material layer on the current collector;
forming a groove on the electrode active material layer; and
filling the groove with a filler comprising a first binder,
wherein the first binder in the filler is present in an amount in a range of about 95 wt % to about 100 wt %.

19. The method of claim 18, wherein forming the groove comprises performing a laser ablation on the electrode active material layer.

20. The method of claim 18, wherein filling the groove with the filler comprising the first binder comprises:
filling the groove with a binder solution comprising the first binder; and
drying the binder solution that fills the groove.
